(19) United States
(12) Patent Application Publication
(10) Pub. No.: US 2019/0337064 A1
(43) Pub. Date: Nov. 7, 2019

(54) CIRCULAR SAW BLADE GUIDE PADS, CIRCULAR SAW GUIDE ASSEMBLIES INCLUDING THE GUIDE PADS, CIRCULAR SAWS INCLUDING THE GUIDE ASSEMBLIES, METHODS OF MANUFACTURING THE GUIDE PADS, AND METHODS OF UTILIZING CIRCULAR SAWS

(71) Applicant: Burton Saw and Supply, L.L.C., Eugene, OR (US)

(72) Inventors: Gary Arthur Stroud, West Kelowna (CA); Craig J. Tompkins, Eugene, OR (US)

(21) Appl. No.: 16/398,797

(22) Filed: Apr. 30, 2019

(30) Foreign Application Priority Data
May 2, 2018 (CA) 3003704

(51) Int. Cl. B23D 47/00

(52) U.S. Cl. CPC B23D 47/005; B23D 59/02

(57) ABSTRACT

Circular saw blade guide pads, circular saw guide assemblies including the guide pads, circular saws including the guide assemblies, methods of manufacturing the guide pads, and methods of utilizing the circular saws. The guide pads include a pad body that includes a pad material. The pad material includes a first plurality of small graphite particles, a second plurality of large graphite particles, and at least one additional component that includes a cured resin material. The guide assemblies include a guide arm and a guide pad operatively attached to the guide arm. The circular saws include at least one circular saw blade that defines a first blade side and an opposed second blade side, a first guide assembly positioned on the first blade side, and a second guide assembly positioned on the second blade side. The methods include methods of operating the circular saws and/or manufacturing the guide pads.

### RELATED APPLICATION

This application claims priority under 35 U.S.C. § 119 to Canada Patent Application No. 3003704, which was filed on May 2, 2018 and entitled “Graphite Guide Pads for Saw Guide Assemblies,” and the complete disclosure of which is incorporated by reference

### FIELD OF THE DISCLOSURE

The present disclosure relates generally to circular saw blade guide pads, to circular saw guide assemblies that include the guide pads, to circular saws that include the guide assemblies, to methods of manufacturing the guide pads, and to methods of utilizing the guide pads.

### BACKGROUND OF THE DISCLOSURE

Circular saw blades rotate at high frequencies within planes commonly referred to as cutting planes. In industrial applications such as in saw mills, individual saw blades in a circular gang saw assembly are stabilized by guide pads, which are designed to minimize deviations from the cutting plane. Saw blades may deviate from the cutting plane with greater frequency and severity as the temperature of the saw blade increases. Friction between a saw blade and its associated guide pads is known to increase saw blade temperature. Accordingly, saw blade guide pads typically are positioned to allow free rotation with exception of unintentional and occasional contact with the guide pad while simultaneously providing minimal clearance between the saw blade and the guide pad (for example, a separation of between about 0.0001″ and about 0.005″) so as to stabilize the rotating saw blade. Guide pads may be dimensioned to include a concave recess from which a pressurized fluid is dispersed toward the saw blade. The pressurized fluid may lubricate and cool the saw blade, while also providing hydraulic support to minimize deviations from the cutting plane. In essence, the pressurized fluid may act as a fluid bearing that limits the frequency and severity of contact between the saw blade and the guide pad.

Many conventional guide pads used in industrial saw mills are produced from Babbitt alloys and are widely referred to as “Babbitt pads.” Babbitt alloys are characterized by dispersions of hard, crystalline, metallic particles in a matrix of soft and/or pliable metallic components. In use, the soft and/or pliable components erode at a faster rate than the hard, metallic particles. As such, the hard, metallic particles are preferentially exposed at the surface of the pad after a wear-in period.

Babbitt pads are associated with numerous shortcomings. For example, the service life of a standard Babbitt pad typically ranges from only 4 hours to a maximum of 60 hours of operation. Hence, industrial saw mills require a constant supply of new Babbitt pads to replace those that have worn out. For this reason, industrial saw mills typically manufacture Babbitt pads on-site by melting down spent Babbitt pads and using the resulting Babbitt alloy to mold new Babbitt pads. This process requires specific equipment, skilled labor, and specialized ventilation and safety equipment.

Saw blade guide pads that utilize alternate materials are known. For example, guide pads based on steel have been proposed. However, steel guide pads have not been widely adopted due, at least in part, to issues associated with increased friction and galling. Likewise, chrome-plated guide pads, bronze-coated guide pads, and ceramic guide pads all have been proposed but are not widely utilized in industrial saw mills.

### SUMMARY OF THE DISCLOSURE

Circular saw blade guide pads, circular saw guide assemblies including the guide pads, circular saws including the guide assemblies, methods of manufacturing the guide pads, and methods of utilizing the circular saws are disclosed. The guide pads include a pad body that includes a pad material. The pad material includes a first plurality of small graphite particles, a second plurality of large graphite particles, and at least one additional component that includes a cured resin material. The first plurality of small graphite particles defines at most a first threshold particle size. The second plurality of large graphite particles defines at least a second threshold particle size that is greater than the first threshold particle size. The cured resin material is bound to the first plurality of small graphite particles and to the second plurality of large graphite particles to define the pad body.

The guide assemblies include a guide arm and a guide pad. The guide pad is operatively attached to the guide arm.

The circular saws include at least one circular saw blade that defines a first blade side and an opposed second blade side. The circular saws also include a first guide assembly positioned on the first blade side and a second guide assembly positioned on the second blade side.

In some examples, the methods include methods of utilizing the circular saws. In these examples, the methods include operating the circular saws for at least a threshold operating time while a guide assembly is positioned on a side of a circular saw blade.

In some examples, the methods include methods of manufacturing circular saw blade guide pads. In these examples, the methods include providing a first plurality of small graphite particles, providing a second plurality of large graphite particles, and providing at least one additional component that includes an uncured resin material. These methods also include forming a mixture of the first plurality of small graphite particles, the second plurality of large graphite particles, and the at least one additional component and curing the mixture to define a pad body of the guide pad.

### BRIEF DESCRIPTION OF THE DRAWINGS

FIG. 1 is a schematic illustration of examples of a circular saw that may include guide assemblies that include circular saw blade guide pads, according to the present disclosure.

FIG. 2 is a less schematic illustration of an example of a circular saw that may include guide assemblies that include circular saw blade guide pads, according to the present disclosure.

FIG. 3 is a less schematic side view illustrating an example of a circular saw that may include guide assemblies that include circular saw blade guide pads, according to the present disclosure.

FIG. 4 is an example of a circular saw blade guide pad according to the present disclosure.

FIG. 5 is a cross-sectional view of the circular saw blade guide pad of FIG. 4 taken along line 5-5 of FIG. 4.

FIG. 6 is another example of a circular saw blade guide pad according to the present disclosure.

FIG. 7 is a cross-sectional view of the circular saw blade guide pad of FIG. 6 taken along line 7-7 of FIG. 6.

FIG. 8 is another example of a circular saw blade guide pad according to the present disclosure.

FIG. 9 is a cross-sectional view of the circular saw blade guide pad of FIG. 8 taken along line 9-9 of FIG. 8.

FIG. 10 is another example of a circular saw blade guide pad according to the present disclosure.

FIG. 11 is a cross-sectional view of the circular saw blade guide pad of FIG. 10 taken along line 11-11 of FIG. 10.

FIG. 12 is a flowchart depicting examples of methods of manufacturing a circular saw blade guide pad, according to the present disclosure.

FIG. 13 is a flowchart depicting examples of methods of utilizing a circular saw, according to the present disclosure.

### DETAILED DESCRIPTION AND BEST MODE OF THE DISCLOSURE

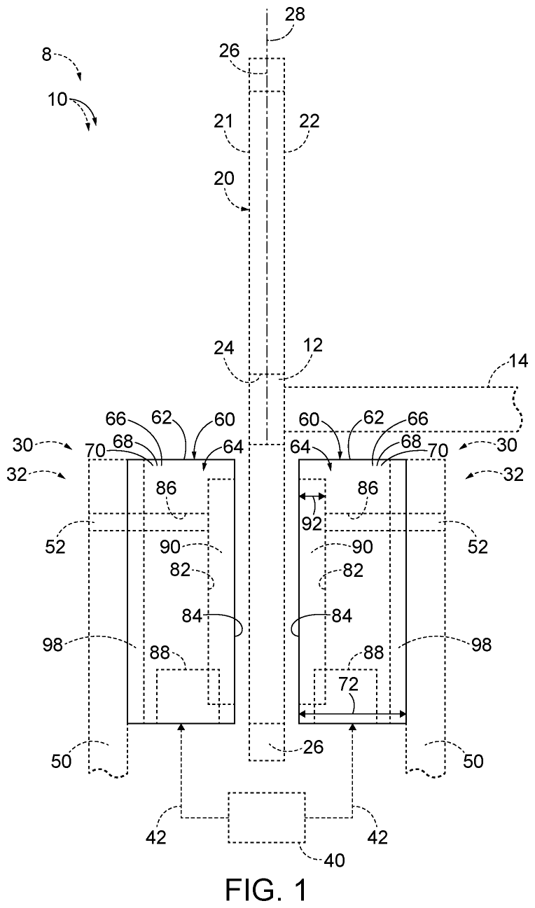

FIGS. 1-13 provide examples of circular saws 10, of guide assemblies 30, of circular saw blade guide pads 60, of methods 500, and/or of methods 600, according to the present disclosure. Elements that serve a similar, or at least substantially similar, purpose are labeled with like numbers in each of FIGS. 1-13 and these elements may not be discussed in detail herein with reference to each of FIGS. 1-13. Similarly, all elements may not be labeled in each of FIGS. 1-13, but reference numerals associated therewith may be utilized herein for consistency. Elements, components, and/or features that are discussed herein with reference to one or more of FIGS. 1-13 may be included in and/or utilized with any of FIGS. 1-13 without departing from the scope of the present disclosure. In general, elements that are likely to be included in a particular embodiment are illustrated in solid lines, while elements that are optional are illustrated in dashed lines. However, elements that are shown in solid lines may not be essential and, in some embodiments, may be omitted without departing from the scope of the present disclosure.

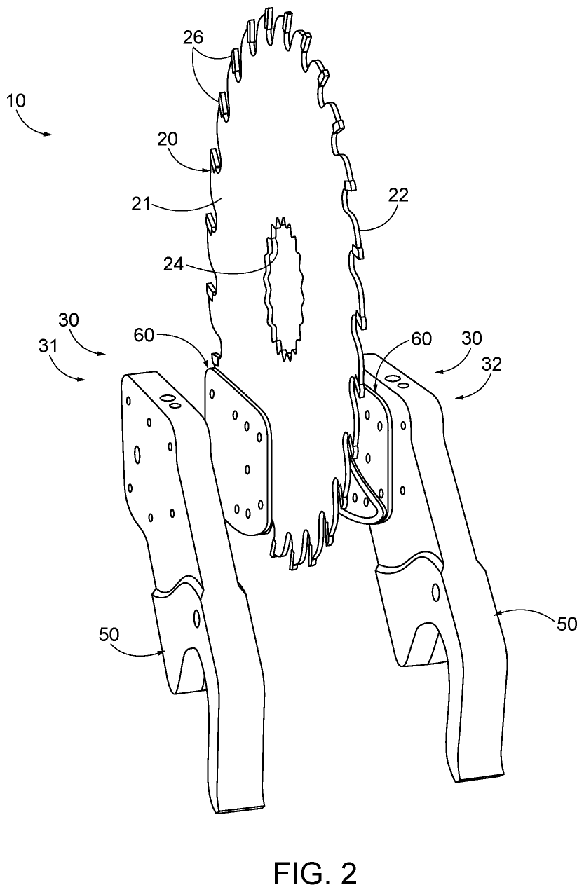

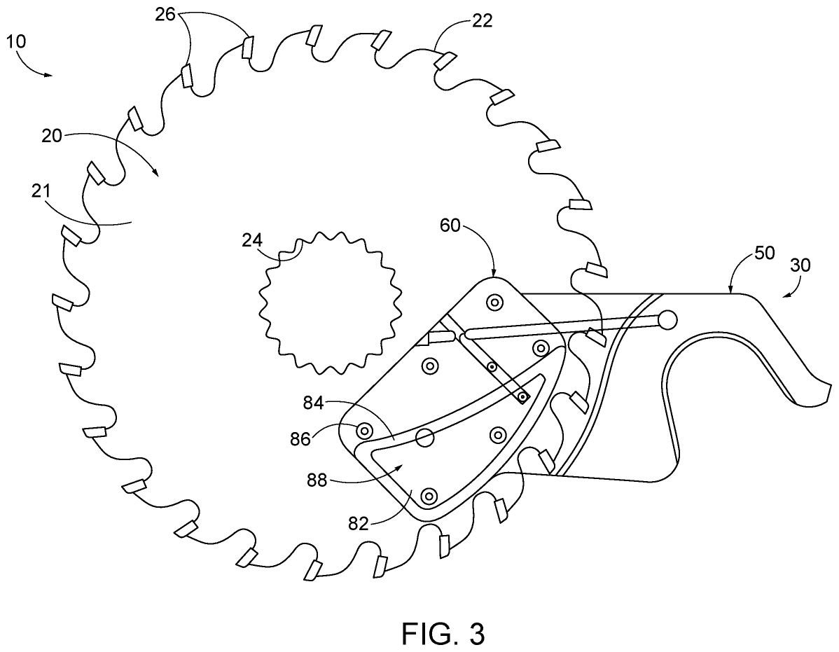

FIG. 1 is a schematic illustration of examples of a circular saw 10 that may include guide assemblies 30 that include circular saw blade guide pads 60, according to the present disclosure. FIG. 2 is a less schematic illustration of an example of a circular saw 10 that may include guide assemblies 30 that include circular saw blade guide pads 60, according to the present disclosure; and FIG. 3 is a less schematic side view illustrating an example of a circular saw 10 that may include guide assemblies 30 that include circular saw blade guide pads 60, according to the present disclosure.

As illustrated in FIGS. 1-3, circular saws 10 include at least one circular saw blade 20 that defines a first blade side 21 and an opposed second blade side 22. Circular saw blade 20 further may include an arbor hole 24 and/or a plurality of teeth 26. Circular saw 10 also includes a plurality of guide assemblies 30, such as a first guide assembly 31 and/or a second guide assembly 32. First guide assembly 31 may be positioned on first blade side 21 of circular saw blade 20, and second guide assembly 32 may be positioned on second blade side 22 of the circular saw blade, as illustrated in FIGS. 1-2.

As illustrated in dashed lines in FIG. 1, circular saws 10 also may include a fluid supply system 40. Fluid supply system 40, when present, may be configured to provide a fluid stream 42 to circular saw blade 20, such as via first guide assembly 31 and/or second guide assembly 32. As discussed in more detail herein, first guide assembly 31 and/or second guide assembly 32 may include a fluid-providing structure 88, and fluid stream 42 may be provided to the circular saw blade via the fluid supply structure, such as to cool, to lubricate, and/or to provide a fluid bearing for the circular saw blade.

During operation of circular saws 10, and with reference to FIG. 1, circular saw blade 20 may rotate, such as about an arbor 12 that may extend within and/or through arbor hole 24. During rotation of the circular saw blade, guide assemblies 30 may retain corresponding circular saw blade guide pads 60 proximal to and/or in contact with corresponding sides of the circular saw blade, and fluid stream 42 may be provided to a space that extends between the circular saw blade and the guide pads. The presence of guide assemblies 30 and/or fluid stream 42 may stabilize circular saw blade 20, thereby decreasing deflection of the circular saw blade and/or deviation of the circular saw blade from a cutting plane 28 thereof.

FIG. 1 illustrates a circular saw 10 that includes a single circular saw blade 20 and a corresponding pair of guide assemblies 30. It is within the scope of the present disclosure that circular saw 10 may include, may be, and/or may form a portion of a circular gang saw 8 that may include a plurality of circular saw blades 20 and a corresponding plurality of pairs of guide assemblies 30. In such a configuration, at least a fraction of the plurality of circular saw blades 20 may be arranged and/or oriented along an arbor shaft 14 that may support a plurality of corresponding arbors 12.

Turning now more generally to FIGS. 1-3, guide assemblies 30 may include a guide arm 50 and a circular saw blade guide pad 60. Guide pad 60 may be operatively attached to guide arm 50, such as via any suitable fastener 52 (shown in FIG. 1). Guide arm 50 may support guide pad 60, may position guide pad 60 relative to circular saw blade 20, and/or may operatively attach guide pad 60 to a remainder of circular saw 10.

Guide arm 50 may include any suitable structure. As an example, guide arm 50 may include and/or be a metallic guide arm 50, a rigid guide arm 50, and/or an at least substantially rigid guide arm 50.

Circular saw 10 and/or guide assembly 30 may be configured such that guide pad 60 may be selectively removed and/or replaced, such as to permit and/or to facilitate continued operation of the circular saw after a given guide pad 60 is worn out or has exhausted its useful service life. As an example, fasteners 52 may be utilized to selectively attach the guide pad to the guide arm and/or to selectively release the guide pad from the guide arm. FIG. 2 schematically illustrates this selective removal and replacement of guide pads 60 by illustrating guide pad 60 of first guide assembly 31 as being separated and/or spaced apart from corresponding guide arm 50.

Circular saw blade guide pads 60, which also may be referred to herein as guide pads 60, may include any suitable structure that may be configured to be supported by guide arm 50 and/or that may be configured to decrease deflection of circular saw blade 20. As an example, and as illustrated in FIG. 1, guide pads 60 may include a pad body 62 that includes, that is formed from, and/or that is defined by a pad material 64. Stated another way, pad body 62 may be formed at least substantially, or even entirely, from pad material 64, pad body 62 may consist of pad material 64, and/or pad body 62 may consist essentially of pad material 64. As examples, pad material 64 may define at least 50 weight percent (wt %), at least 60 wt %, at least 70 wt %, at least 80 wt %, at least 90 wt %, at least 95 wt %, at least 99 wt %, or 100 wt % of the pad body. Pad body 62 may include, may form, and/or may define a guide surface 84 that may be configured to contact, to directly contact, to physically contact, and/or to at least intermittently contact the circular saw blade, as discussed in more detail herein.

Pad material 64 may include and/or utilize graphite as a solid lubricant. Pad body 62 may be in the form of an extruded pad body, a coarse extruded graphite pad body, a medium extruded graphite pad body, a molded pad body, a machined pad body, a subtractively machined pad body, and/or an additively machined pad body. Pad material 64 additionally or alternatively may include solid expanded graphite, intercalated solid graphite, and/or solid synthetic graphite.

In one example, pad material 64 includes a first plurality of small graphite particles 66 and a second plurality of large graphite particles 68. In this example, pad material 64 also includes at least one additional component 70.

First plurality of small graphite particles 66 also may be referred to herein as small graphite particles 66 and/or as small particles 66. Small particles 66 may include and/or be naturally occurring small graphite particles. Stated another way, small particles 66 may be mined small particles 66 and/or may not be artificially created small particles 66.

Small particles 66 may define a first weight percentage of pad material 64. Examples of the first weight percentage of the pad material include at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, at least 30 wt %, at least 32 wt %, at least 34 wt %, at least 36 wt %, at least 38 wt %, at least 40 wt %, at least 42 wt %, at least 44 wt %, at least 46 wt %, at least 48 wt %, and/or at least 50 wt % of the pad material. Additional or alternative examples of the first weight percentage of the pad material include at most 60 wt %, at most 58 wt %, at most 56 wt %, at most 54 wt %, at most 52 wt %, at most 50 wt %, at most 48 wt %, at most 46 wt %, at most 44 wt %, at most 42 wt %, at most 40 wt %, at most 38 wt %, at most 36 wt %, at most 34 wt %, at most 32 wt %, at most 30 wt % at most 28 wt %, at most 26 wt %, at most 24 wt %, at most 22 wt %, and/or at most 20 wt % of the pad material.

A first threshold fraction of small particles 66 may define at most a first threshold particle size. Examples of the first threshold fraction of small particles 66 include at least 70 wt %, at least 72 wt %, at least 74 wt %, at least 76 wt %, at least 78 wt %, at least 80 wt %, at least 82 wt %, at least 84 wt %, at least 86 wt %, at least 88 wt %, at least 90 wt %, at least 92 wt %, at least 94 wt %, at least 96 wt %, and/or at least 98 wt % of the first plurality of small graphite particles. Additional or alternative examples of the first threshold fraction of small particles 66 include at most 100 wt %, at most 98 wt %, at most 96 wt %, at most 94 wt %, at most 92 wt %, at most 90 wt %, at most 88 wt %, at most 86 wt %, at most 84 wt %, at most 82 wt %, and/or at most 80 wt % of the first plurality of small graphite particles.

Examples of the first threshold particle size include at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, at least 95 microns, and/or at least 100 microns. Additional or alternative examples of the first threshold particle size include at most 140 microns, at most 130 microns, at most 120 microns, at most 110 microns, at most 100 microns, at most 90 microns, at most 80 microns, at most 70 microns, at most 60 microns, and/or at most 50 microns.

Second plurality of large graphite particles 68 also may be referred to herein as large graphite particles 68 and/or as large particles 68. Large particles 68 may include and/or be naturally occurring large graphite particles. Stated another way, large particles 68 may be mined large particles 68 and/or may not be artificially created large particles 68.

A second threshold fraction of large particles 68 defines at least a second threshold particle size. The second threshold particle size is greater than the first threshold particle size of small particles 66. As examples, a ratio of the first threshold particle size to the second threshold particle size may be at least 0.1, at least 0.2, at least 0.3, at least 0.4, and/or at least 0.5. As additional or alternative examples, the ratio of the first threshold particle size to the second threshold particle size may be at most 0.8, at most 0.7, at most 0.6, at most 0.5, at most 0.4, at most 0.3, and/or at most 0.2.

The first threshold particle size and the second threshold particle size may be similarly defined and/or measured. Examples of the first threshold particle size and/or of the second threshold particle size include a maximum extent of the corresponding particles, a mean maximum extent of the corresponding particles, a median maximum extent of the corresponding particles, a radius of the corresponding particles, a mean radius of the corresponding particles, a median radius of the corresponding particles, an effective radius of the corresponding particles, a mean effective radius of the corresponding particles, and/or a median effective radius of the corresponding particles.

Large particles 68 may define a second weight percentage of pad material 64. Examples of the second weight percentage of the pad material include at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, at least 30 wt %, at least 32 wt %, at least 34 wt %, at least 36 wt %, at least 38 wt %, at least 40 wt %, at least 42 wt %, at least 44 wt %, at least 46 wt %, at least 48 wt %, and/or at least 50 wt % of the pad material. Additional or alternative examples of the second weight percentage of the pad material include at most 60 wt %, at most 58 wt %, at most 56 wt %, at most 54 wt %, at most 52 wt %, at most 50 wt %, at most 48 wt %, at most 46 wt %, at most 44 wt %, at most 42 wt %, at most 40 wt %, at most 38 wt %, at most 36 wt %, at most 34 wt %, at most 32 wt %, at most 30 wt % at most 28 wt %, at most 26 wt %, at most 24 wt %, at most 22 wt %, and/or at most 20 wt % of the pad material.

Examples of the second threshold fraction of large particles 68 include at least 50 wt %, at least 52 wt %, at least 54 wt %, at least 56 wt %, at least 58 wt %, at least 60 wt %, at least 62 wt %, at least 64 wt %, at least 66 wt %, at least 68 wt %, at least 70 wt %, at least 72 wt %, at least 74 wt %, at least 76 wt %, at least 78 wt %, at least 80 wt %, at least 82 wt %, at least 84 wt %, at least 86 wt %, at least 88 wt %, at least 90 wt %, at least 92 wt %, at least 94 wt %, at least 96 wt %, and/or at least 98 wt % of the second plurality of large graphite particles. Additional or alternative examples of the second threshold fraction of large particles 68 include at most 100 wt %, at most 98 wt %, at most 96 wt %, at most 94 wt %, at most 92 wt %, at most 90 wt %, at most 88 wt %, at most 86 wt %, at most 84 wt %, at most 82 wt %, at most 80 wt %, at most 78 wt %, at most 76 wt %, at most 74 wt %, at most 72 wt %, at most 70 wt %, at most 68 wt %, at most 66 wt %, at most 64 wt %, at most 62 wt %, and/or at most 60 wt % of the second plurality of large graphite particles.

Examples of the second threshold particle size include at least 100 microns, at least 110 microns, at least 120 microns, at least 130 microns, at least 140 microns, at least 150 microns, at least 160 microns, at least 170 microns, at least 180 microns, at least 190 microns, and/or at least 200 microns. Additional or alternative examples of the second threshold particle size include at most 400 microns, at most 350 microns, at most 300 microns, at most 250 microns, at most 240 microns, at most 230 microns, at most 220 microns, at most 210 microns, at most 200 microns, at most 190 microns, at most 180 microns, at most 170 microns, at most 160 microns, and/or at most 150 microns.

It is within the scope of the present disclosure that large particles 68 may include a first subset of large graphite particles and a second subset of large graphite particles. The first subset of large graphite particles may define a first subset particle size range and the second subset of large graphite particles may define a second subset particle size range. The second subset particle size range may be greater than the first subset particle size range.

Examples of the first subset particle size range include at least 100 microns, at least 110 microns, at least 120 microns, at least 130 microns, at least 140 microns, at least 150 microns, at least 160 microns, at least 170 microns, at least 180 microns, at least 190 microns, and/or at least 200 microns. Additional or alternative examples of the first subset particle size range include at most 210 microns, at most 200 microns, at most 190 microns, at most 180 microns, at most 170 microns, at most 160 microns, and/or at most 150 microns.

Examples of the second subset particle size range include at least 150 microns, at least 160 microns, at least 170 microns, at least 180 microns, at least 190 microns, at least 200 microns, at least 210 microns, at least 220 microns, at least 230 microns, at least 240 microns, and/or at least 250 microns. Additional or alternative examples of the second subset particle size range include at most 400 microns, at most 350 microns, at most 300 microns, at most 250 microns, at most 240 microns, at most 230 microns, at most 220 microns, at most 210 microns, and/or at most 200 microns.

The first subset of large graphite particles may define any suitable fraction of large particles 68. As examples, the first subset of large graphite particles may define at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, and/or at least 30 wt % of large particles 68. Additionally or alternatively, the first subset of large graphite particles may define at most 50 wt %, at most 48 wt %, at most 46 wt %, at most 44 wt %, at most 42 wt %, at most 40 wt %, at most 38 wt %, at most 36 wt %, at most 34 wt %, at most 32 wt %, and/or at most 30 wt % of large particles 68.

Similarly, the second subset of large graphite particles may define any suitable fraction of large particles 68. As examples, the second subset of large graphite particles may define at least 40 wt %, at least 42 wt %, at least 44 wt %, at least 46 wt %, at least 48 wt %, at least 50 wt %, at least 52 wt %, at least 54 wt %, at least 56 wt %, at least 58 wt %, and/or at least 60 wt % of large particles 68. Additionally or alternatively, the second subset of large graphite particles may define at most 80 wt %, at most 78 wt %, at most 76 wt %, at most 74 wt %, at most 72 wt %, at most 70 wt %, at most 68 wt %, at most 66 wt %, at most 64 wt %, at most 62 wt %, and/or at most 60 wt % of large particles 68.

At least one additional component 70 defines a remainder of pad material 64. Stated another way small particles 66 may define the first weight percentage of the pad material, large particles 68 may define the second weight percentage of the pad material, and at least one additional component 70 may define a remaining weight percentage of the pad material, with the first weight percentage, the second weight percentage, and the remaining weight percentage summing to 100 percent.

Additional component 70 includes a cured resin material. The cured resin material is bound to small particles 66 and also to large particles 68 to form and/or define pad body 62. Examples of the resin material, or of the cured resin material, include a polymeric resin material, a cross-linked polymeric resin material, an epoxy resin material, a phenolic resin material, a phenol formaldehyde resin material, and/or a phenolic resin material that includes methacrylate-functionalized silicates.

The resin material, or the cured resin material, may form and/or define any suitable portion, fraction, or weight percentage of the remainder of the pad material. As examples, the resin material may define at least 0.1 wt %, at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, and/or at least 99.9 wt % of the remainder of the pad material. Additionally or alternatively, the resin material may define at most 100 wt %, at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, and/or at most 0.1 wt % of the remainder of the pad material.

In addition to the cured resin material, at least one additional component 70 may include and/or may be defined by fiberglass, formaldehyde, magnesium oxide, mica, mineral fiber, and/or woolastonite. Each of the fiberglass, the formaldehyde, the magnesium oxide, the mica, the mineral fiber, and/or the woolastonite may form and/or define any suitable portion, fraction, and/or weight percentage of the remainder of the pad material. As examples, the fiberglass, the formaldehyde, the magnesium oxide, the mica, the mineral fiber, and/or the woolastonite individually or collectively may define at least 0.1 wt %, at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, and/or at least 99.9 wt % of the remainder of the pad material. As additional or alternative examples, the fiberglass, the formaldehyde, the magnesium oxide, the mica, the mineral fiber, and/or the woolastonite individually or collectively may define at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, and/or at most 0.1 wt % of the remainder of the pad material.

As illustrated in dashed lines in FIG. 1, guide assembly 30 and/or guide pad 60 may include a support fabric 98. Support fabric 98, when present, may be configured to support pad body 62, to provide shock absorption for pad body 62, and/or to decrease a potential for cracking of pad body 62. Support fabric 98 may be incorporated into guide assembly 30 and/or guide pad 60 in any suitable manner. As an example, the support fabric may be embedded within the pad body. As another example, pad body 62 may be operatively attached, or adhered, to the support fabric. Examples of support fabric 98 include a plant-based fabric, a cotton fabric, a flax-fiber fabric, a hemp-fiber fabric, a synthetic fabric, a polyester fabric, a nylon fabric, and/or a poly (paraphenylene terephthalamide) fabric. Additional examples of the support fabric include a plain-weave medium-weight support fabric. The support fabric may be combined with a mixture of a graphite particles, or powder, and uncured resin, which is then formed into a solid plate.

Pad body 62 and/or pad material 64 thereof may have and/or define any suitable physical properties, examples of which are disclosed herein. The disclosed properties may be measured and/or determined by and/or utilizing ASTM D-349.

As an example, pad body 62 may have an M-scale Rockwell hardness of at least 60, at least 65, at least 70, at least 75, at least 80, at least 85, at least 90, at least 95, and/or at least 100. Additionally or alternative, the pad body may have an M-scale Rockwell hardness of at most 120, at most 115, at most 110, at most 105, at most 100, at most 95, at most 90, at most 85, and/or at most 80.

As another example, pad body 62 may have a flexural strength of at least 15,000 psi, at least 15,500 psi, at least 16,000 psi, at least 16,500 psi, at least 17,000 psi, at least 17,500 psi, at least 18,000 psi, at least 18,500 psi, and/or at least 18,000 psi. Additionally or alternatively, the pad body may have a flexural strength of at most 22,000 psi, at most 21,500 psi, at most 21,000 psi, at most 20,500 psi, at most 20,000 psi, at most 19,500 psi, at most 19,000 psi, at most 18,500 psi, and/or at most 18,000 psi.

As yet another example, pad body 62 may have a tensile strength of at least 7,000 psi, at least 7,500 psi, at least 8,000 psi, at least 8,500 psi, at least 9,000 psi, at least 9,500 psi, and/or at least 10,000 psi. Additionally or alternatively, the pad body may have a tensile strength of at most 12,000 psi, at most 11,500 psi, at most 11,000 psi, at most 10,500 psi, at most 10,000 psi, at most 9,500 psi, and/or at most 9,000 psi.

As another example, pad body 62 may have a compressive strength of at least 25,000 psi, at least 25,500 psi, at least 26,000 psi, at least 26,500 psi, at least 27,000 psi, at least 27,500 psi, at least 28,000 psi, at least 28,500 psi, and/or at least 29,000 psi. Additionally or alternatively, the pad body may have a compressive strength of at most 32,000 psi, at most 31,500 psi, at most 31,000 psi, at most 30,500 psi, at most 30,000 psi, at most 29,500 psi, at most 29,000 psi, at most 28,500 psi, and/or at most 28,000 psi.

As illustrated in dashed lines in FIG. 1, guide pad 60 and/or pad body 62 thereof may include, form, and/or define both guide surface 84 and a recessed surface 82. Guide surface 84 also may be referred to herein as a distal surface 84, and recessed surface 82 also may be referred to herein as a proximal surface 82. Guide surface 84 and recessed surface 82 may be parallel to one another, with guide surface 84 extending away from a remainder of pad body 62 relative to recessed surface 82. Guide surface 84 and recessed surface 82 together may define a recessed pocket 90. Recessed pocket 90 may have and/or define a pocket depth 92.

Examples of pocket depth 92 include depths of at least 0.1 millimeter (mm), at least 0.15 mm, at least 0.2 mm, at least 0.25 mm, at least 0.3 mm, at least 0.4 mm, at least 0.5 mm, at least 0.75 mm, at least 1 mm, at least 1.5 mm, and/or at least 2 mm. Additional or alternative examples of pocket depth 92 include depths of at most 5 mm, at most 4.5 mm, at most 4 mm, at most 3.5 mm, at most 3 mm, at most 2.5 mm, at most 2 mm, at most 1.5 mm, at most 1 mm, and/or at most 0.5 mm.

Guide pad 60 and/or pad body 62 thereof may have and/or define any suitable pad thickness 72. Examples of pad thickness 72 include thicknesses of at least 2 mm, at least 2.5 mm, at least 3 mm, at least 3.5 mm, at least 4 mm, at least 4.5 mm, at least 5 mm, at least 5.5 mm, and/or at least 6 mm. Additional or alternative examples of the pad thickness include thicknesses of at most 10 mm, at most 9.5 mm, at most 9 mm, at most 8.5 mm, at most 8 mm, at most 7.5 mm, at most 7 mm, at most 6.5 mm, at most 6 mm, at most 5.5 mm, and/or at most 5 mm.

It is within the scope of the present disclosure that recessed pocket 90 may be configured to retain, or to at least temporarily retain, a fluid, such as from fluid stream 42. The fluid may lubricate and/or cool circular saw blade 20 in proximity to guide pad 60. Examples of the fluid include water, an aqueous solution, oil, and/or an oil-based solution.

In some examples, and as discussed, the fluid may be provided via one or more fluid-providing structures 88 that may be at least partially defined by and/or within guide pad 60. As an example, and as discussed in more detail herein, fluid-providing structures 88 may include fluid-providing apertures that may extend, or open, into recessed pocket 90. Guide pads 60 may include any suitable number of fluid-providing apertures. As examples, guide pads 60 may include at least 1, at least 2, at least 3, at least 4, at least 6, at least 8, at least 10, at least 12, at least 14, at least 16, at least 18, and/or at least 20 fluid-providing apertures. As additional or alternative examples, guide pads 60 may include at most 30, at most 25, at most 20, at most 18, at most 16, at most 14, at most 12, at most 10, at most 8, at most 6, and/or at most 4 fluid-providing apertures. The fluid-providing apertures may be spaced-apart within guide pads 60 in any suitable manner. As an example, the fluid-providing apertures may be spaced-apart around a periphery of recessed pocket 90, may be spaced-apart within a central portion of the recessed pocket, and/or may be spaced-apart around guide surface 84.

As another example, and as discussed in more detail herein, fluid-providing structures 88 may be or include fluid-providing channels. The fluid-providing channels may be defined within recessed surface 82 and may be in fluid communication with the fluid-providing apertures. The presence of the fluid-providing channels may increase a distribution of fluid between the guide pad and the circular saw blade. The fluid-providing channels may have and/or define any suitable shape, examples of which include sinusoidal shapes, a central channel with a plurality of outward-extending side channels, and/or elliptical shapes.

As illustrated in dashed lines in FIG. 1, guide pads 60 may include, may form, and/or may define one or more fastener-receiving apertures 86. The fastener-receiving apertures may be dimensioned and/or positioned to connect the guide pad 60 to guide arm 50, such as via fasteners 52.

Guide pads 60 may include any suitable number of fastener-receiving apertures 86. As examples, guide pads 60 may include at least 1, at least 2, at least 3, at least 4, at least 6, at least 8, at least 10, at least 12, at least 14, at least 16, at least 18, and/or at least 20 fastener-receiving apertures. As additional or alternative examples, guide pads 60 may include at most 30, at most 25, at most 20, at most 18, at most 16, at most 14, at most 12, at most 10, at most 8, at most 6, and/or at most 4 fastener-receiving apertures. The fastener-receiving apertures may be spaced-apart within guide pads 60 in any suitable manner. As an example, the fastener-receiving apertures may be spaced-apart around a periphery of recessed pocket 90, may be spaced-apart within a central portion of the recessed pocket, and/or may be spaced-apart around guide surface 84.

Fastener-receiving apertures 86 may have and/or define any suitable shape and/or shapes. As examples the fastener-receiving apertures may be circular, oval, triangular, and/or rectangular. As a specific example, fastener-receiving apertures 86 may be circular and may be defined by recessed surfaces that are dimensioned to receive corresponding fasteners 52 in such a way that the fasteners are flush (or recessed) relative to the surface of the saw blade guide pad.

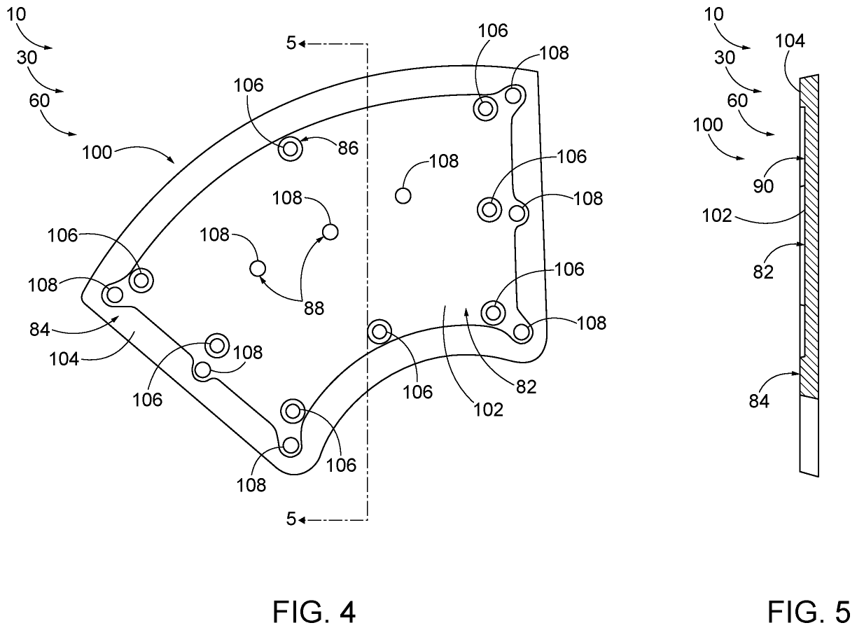

FIGS. 4-11 provide more specific and/or less schematic examples of circular saw blade guide pads 60 that may be included in guide assemblies 30 and/or circular saws 10, according to the present disclosure. FIGS. 4-11 may be more detailed and/or less schematic illustrations of guide pads 60 that are illustrated in FIGS. 1-3. With this in mind, any structure, function, and/or feature of circular saws 10, guide assemblies 30, and/or guide pads 60 that are discussed herein with reference to FIGS. 1-3 may be included in and/or utilized with circular saws 10, guide assemblies 30, and/or guide pads 60 of FIGS. 4-11 without departing from the scope of the present disclosure. Similarly, any structure, function, and/or feature of circular saws 10, guide assemblies 30, and/or guide pads 60 that are discussed herein with reference to FIGS. 4-11 may be included in and/or utilized with circular saws 10, guide assemblies 30, and/or guide pads 60 of FIGS. 1-3 without departing from the scope of the present disclosure.

FIG. 5 shows a plan view of an example of a guide pad 60, which also may be referred to herein as a graphite saw blade guide pad 100, according to the present disclosure. Graphite saw blade guide pad 100 includes a recessed surface 82, which also may be referred to herein as a proximal surface 102, and a guide surface 84, which also may be referred to herein as a distal surface 104. Proximal surface 102 and distal surface 104 are substantially parallel to one another, with distal surface 104 being raised relative to proximal surface 102.

Graphite saw blade guide pad 100 also includes a fluid-providing structure 88 in the form of a plurality of fluid-providing apertures 108. A subset of the plurality of fluid-providing apertures 108 is disposed about a peripheral portion of the graphite saw blade guide pad 100 such that they are adjacent to distal surface 104. A different subset of the plurality of fluid-providing apertures 108 is disposed about the center of the graphite saw blade guide pad 100.

The saw blade guide pad 100 also includes a plurality of fastener-receiving apertures 86, which also may be referred to herein as fastener-receiving apertures 106. Fastener-receiving apertures 106 are disposed about a peripheral portion of the graphite saw blade guide pad 100 such that they are adjacent to the distal surface 104. The fastener-receiving apertures 106 are defined by recessed surfaces that are dimensioned to receive fasteners in such a way that the fasteners are flush (or recessed) relative to the surface of the graphite saw blade guide pad 100.

FIG. 5 shows a cross-sectional view of the graphite saw blade guide pad 100 sectioned along the line 5-5 of FIG. 4. In this view, a recessed pocket 90 formed by the distal surface 104, which is raised relative to the proximal surface 102, is readily apparent. In this example, the distal surface 104 is raised relative to the proximal surface 102 by about 1.5 mm (0.06″), and the graphite saw blade guide pad has a thickness of about 5.8 mm (0.23″).

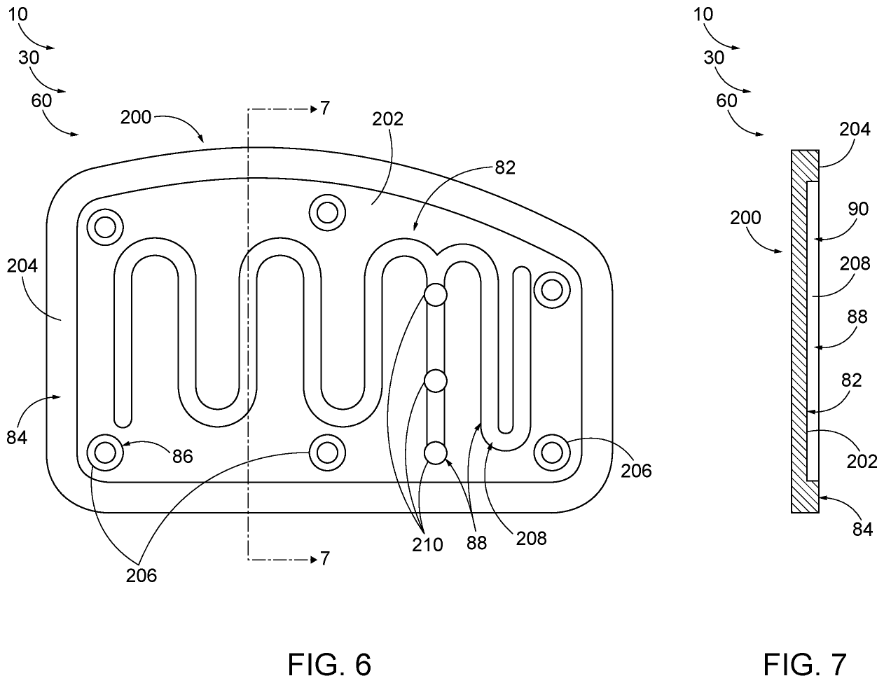

FIG. 6 shows a plan view of another example of a guide pad 60, which also may be referred to herein as a graphite saw blade guide pad 200, according to the present disclosure. Graphite saw blade guide pad 200 includes a recessed surface 82, which also may be referred to herein as a proximal surface 202, and a guide surface 84, which also may be referred to herein as a distal surface 204. Proximal surface 202 and distal surface 204 are substantially parallel to one another, with distal surface 204 being raised relative to proximal surface 202.

The graphite saw blade guide pad 200 also includes a fluid-providing structure 88 in the form of a sinusoidal fluid-providing channel 208 machined into proximal surface 202. Fluid-providing structure 88 also includes a plurality of fluid-providing apertures 210, which may be spaced-apart along channel 208. A depth for the channel 208 may be selected from a range of 0.01 mm (0.04″) to about 1.0 mm (0.4″).

The saw blade guide pad 200 also includes a plurality of fastener-receiving apertures 86, which also may be referred to herein as fastener-receiving apertures 206. Fastener-receiving apertures 206 are disposed about a peripheral portion of the graphite saw blade guide pad 200 such that they are adjacent to the distal surface 204. The fastener-receiving apertures 206 are defined by recessed surfaces that are dimensioned to receive fasteners in such a way that the fasteners are flush (or recessed) relative to the surface of the graphite saw blade guide pad 200.

FIG. 7 shows a cross-sectional view of the graphite saw blade guide pad 200 sectioned along the line 7-7 of FIG. 6. In this view, a recessed pocket 90 formed by the distal surface 204, which is raised relative to the proximal surface 202, is readily apparent. In this example, the distal surface 204 is raised relative to the proximal surface 202 by about 1.5 mm (0.06″), the graphite saw blade guide pad has a thickness of about 5.8 mm (0.23″), and the depth of the channel 208 is about 0.5 mm (0.02″).

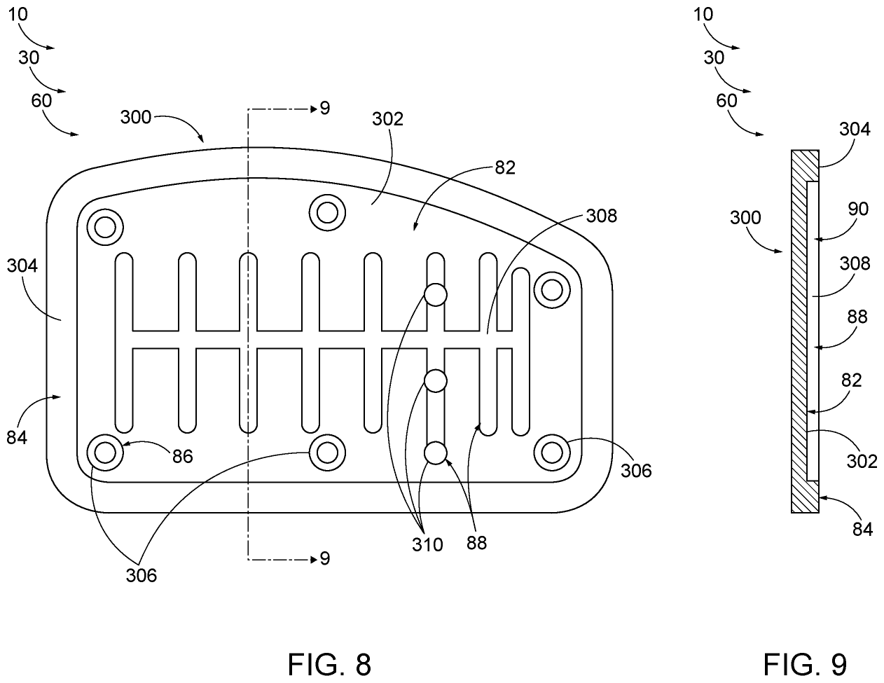

FIG. 8 shows a plan view of another example of a guide pad 60, which also may be referred to herein as a graphite saw blade guide pad 300, according to the present disclosure. The graphite saw blade guide pad 300 includes a recessed surface 82, which also may be referred to herein as a proximal surface 302, and a guide surface 84, which also may be referred to herein as a distal surface 304. The proximal surface 302 and the distal surface 304 are substantially parallel to one another, with distal surface 304 being raised relative to proximal surface 302.

Graphite saw blade guide pad 300 also includes a fluid-providing structure 88 in the form of a fluid-providing channel 308 machined into the proximal surface 302, wherein the fluid-providing channel 308 has a central channel with a plurality of side-channels extending out at 90° from both sides of the central channel. Fluid-providing structure 88 also includes a plurality of fluid-providing apertures 310 that may be provided along channel 308. In this example, a depth for the channel 308 may be selected from a range of 0.01 mm (0.04″) to about 1.0 mm (0.4″).

The saw blade guide pad 300 also includes a plurality of fastener-receiving apertures 86, which also may be referred to herein as fastener-receiving apertures 306. Fastener-receiving apertures 306 are disposed about a peripheral portion of the graphite saw blade guide pad 300 such that they are adjacent to the distal surface 304. Fastener-receiving apertures 306 are defined by recessed surfaces that are dimensioned to receive fasteners in such a way that the fasteners are flush (or recessed) relative to the surface of the graphite saw blade guide pad 300.

FIG. 9 shows a cross-sectional view of graphite saw blade guide pad 300 sectioned along the line 9-9 of FIG. 8. In this view, a recessed pocket 90 formed by the distal surface 304, which is raised relative to the proximal surface 302, is readily apparent. In this example, the distal surface 304 is raised relative to the proximal surface 302 by about 1.5 mm (0.06″), the graphite saw blade guide pad has a thickness of about 5.8 mm (0.23″), and the depth of the channel 308 is about 0.5 mm (0.02″).

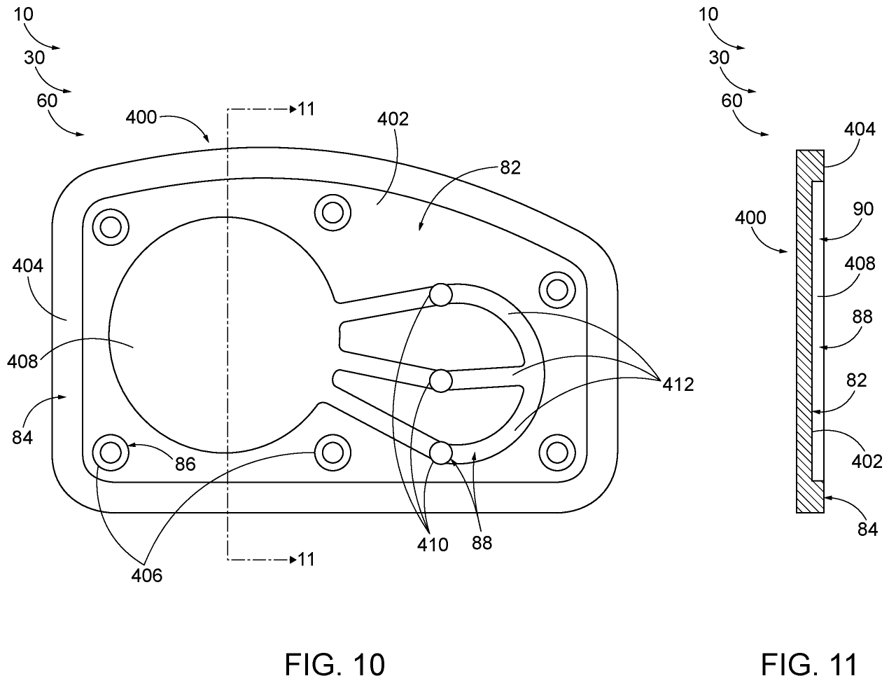

FIG. 10 shows a plan view of another example of a guide pad 60, which also may be referred to herein as a graphite saw blade guide pad 400, according to the present disclosure. Graphite saw blade guide pad 400 includes a recessed surface 82, which also may be referred to herein as a proximal surface 402, and a guide surface 84, which also may be referred to herein as a distal surface 404. The proximal surface 402 and the distal surface 404 are substantially parallel to one another, with distal surface 404 being raised relative to proximal surface 402.

The graphite saw blade guide pad 400 also includes a fluid-providing structure 88 in the form of a fluid-providing circular cavity 408 machined into the proximal surface 402, wherefrom extend a plurality of interconnected fluid-providing channels 412. Fluid-providing structure 88 also includes a plurality of fluid-providing apertures 410 that may be spaced-apart along channels 412 and/or within circular cavity 408. In this example, a depth for circular cavity 408 and plurality of fluid-providing channels may be selected from a range of 0.01 mm (0.04″) to about 1.0 mm (0.4″).

Saw blade guide pad 400 also includes a plurality of fastener-receiving apertures 86, which also may be referred to herein as fastener-receiving apertures 406. Fastener-receiving apertures 406 are positioned about a peripheral portion of the graphite saw blade guide pad 400 such that they are adjacent to the distal surface 404. The fastener-receiving apertures 406 are defined by recessed surfaces that are dimensioned to receive fasteners in such a way that the fasteners are flush (or recessed) relative to the surface of the graphite saw blade guide pad 400.

FIG. 11 shows a cross-sectional view of the graphite saw blade guide pad 400 sectioned along the line 11-11 of FIG. 10. In this view, a recessed pocket 90 formed by the distal surface 404, which is raised relative to the proximal surface 402, is readily apparent. In this example, the distal surface 404 is raised relative to the proximal surface 402 by about 1.5 mm (0.06″), the graphite saw blade guide pad has a thickness of about 5.8 mm (0.23″), and the depth of the channels 412 is about 0.5 mm (0.02″).

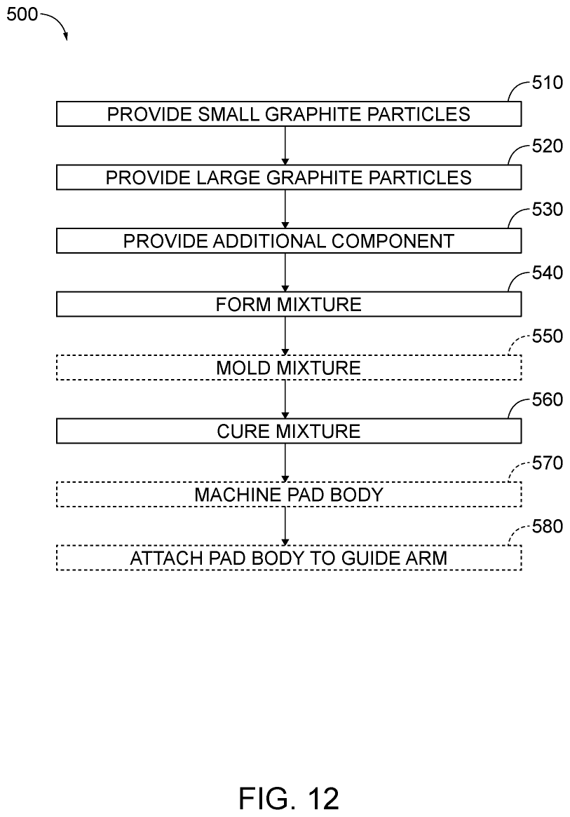

FIG. 12 is a flowchart illustrating examples of methods 500 of manufacturing a circular saw blade guide pad, according to the present disclosure. Methods 500 include providing small graphite particles at 510 and providing large graphite particles at 520. Methods 500 also include providing an additional component at 530 and forming a mixture at 540. Methods 500 may include molding the mixture at 550 and include curing the mixture at 560. Methods 500 further may include machining a pad body at 570 and/or attaching the pad body to a guide arm at 580.

Providing small graphite particles at 510 may include providing a first plurality of small graphite particles. Examples of the first plurality of small graphite particles are disclosed herein with reference to first plurality of small graphite particles 66 of FIG. 1. A first threshold fraction of the first plurality of small graphite particles may define at most a first threshold particle size. Examples of the first threshold fraction of the first plurality of small graphite particles and of the first threshold particle size are disclosed herein.

Providing large graphite particles at 520 may include providing a second plurality of large graphite particles. Examples of the second plurality of large graphite particles are disclosed herein with reference to second plurality of large graphite particles 68 of FIG. 1. A second threshold fraction of the second plurality of large graphite particles may define at least a second threshold particle size. Examples of the second threshold fraction of the second plurality of large graphite particles and of the second threshold particle size are disclosed herein.

Providing the additional component at 530 may include providing at least one suitable additional component. The at least one additional component includes an uncured resin material, examples of which are disclosed herein.

Forming the mixture at 540 may include forming a mixture of the first plurality of small graphite particles, the second plurality of large graphite particles, and the at least one additional component. The first plurality of small graphite particles forms a first weight percentage of the mixture, and examples of the first weight percentage of the mixture are disclosed herein with reference to the first weight percentage of pad material 64. The second plurality of large graphite particles forms a second weight percentage of the mixture, and examples of the second weight percentage of the mixture are disclosed herein with reference to the second weight percentage of pad material 64. The at least one additional component forms a remainder of the mixture. Examples of the remainder of the mixture are disclosed herein with reference to the remainder of pad material 64.

As discussed in more detail herein, the at least one additional component also may include fiberglass, formaldehyde, magnesium oxide, mica, mineral fiber, and/or woolastonite. Examples of a remainder of the mixture that may be defined by fiberglass, formaldehyde, magnesium oxide, mica, mineral fiber, and/or woolastonite are disclosed herein with reference to the remainder of pad material 64 that may be defined by fiberglass, formaldehyde, magnesium oxide, mica, mineral fiber, and/or woolastonite.

Molding the mixture at 550 may include positioning the mixture within a mold and may be performed subsequent to the forming at 540 and/or prior to the curing at 560. This may include positioning such that, subsequent to the curing at 560, a shape of the guide pad corresponds to a shape of the mold. Stated another way, the mold may be shaped to define a final, or a desired, shape for the guide pad, and the molding at 550 may include forming the mixture into the final, or the desired, shape for the guide pad.

Curing the mixture at 560 may include curing to bind the resin material to the first plurality of small graphite particles and also to the second plurality of large graphite particles. Additionally or alternatively, the curing at 560 may include solidifying the mixture and/or forming, or defining, a pad body of the guide pad. Examples of the pad body are disclosed herein with reference to pad body 62.

Machining the pad body at 570 may include machining the pad body to form at least one surface of the guide pad, to form at least one aperture within the guide pad, to form at least one recessed surface within the guide pad, to form at least one guide surface of the guide pad, and/or to define at least one fluid-providing structure of the guide pad. Examples of the aperture are disclosed herein with reference to fastener-receiving apertures 86. Examples of the recessed surface are disclosed herein with reference to recessed surface 82. Examples of the guide surface are disclosed herein with reference to guide surface 84. Examples of the fluid-providing structure are disclosed herein with reference to fluid-providing structure 88. The machining at 570 may be performed subsequent to the curing at 560 and/or prior to the attaching at 580, when performed. It is within the scope of the present disclosure that the machining at 570 additionally or alternatively may include or utilize other additive or subtractive manufacturing/machining techniques or processes.

Attaching the pad body to the guide arm at 580 may include operatively attaching the pad body to any suitable guide arm. This may include attaching to define a circular saw guide assembly, such as circular saw guide assemblies 30 that are disclosed herein. Additionally or alternatively, the attaching at 580 may include attaching to incorporate the guide pad into a circular saw, such as circular saws 10 that are disclosed herein.

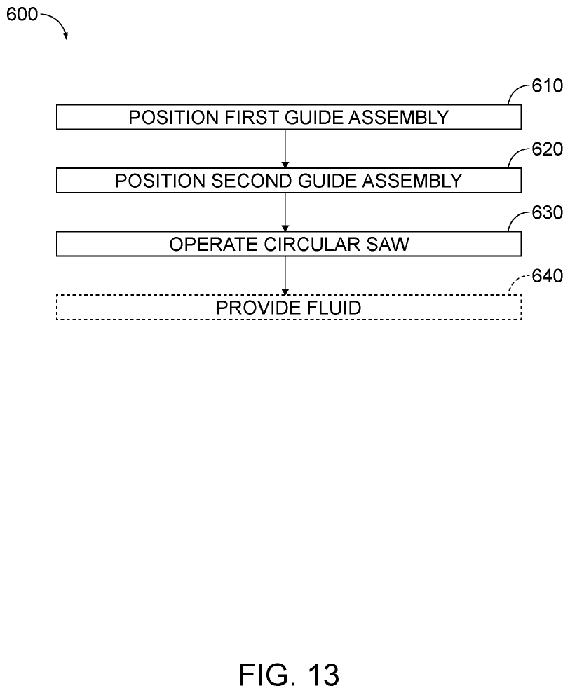

FIG. 13 is a flowchart illustrating examples of methods 600 of utilizing a circular saw, according to the present disclosure. Methods 600 also may be referred to herein as methods of stabilizing a circular saw blade, according to the present disclosure and include positioning a first guide assembly at 610 and positioning a second guide assembly at 620. Methods 600 also include operating the circular saw at 630 and may include providing a fluid at 640.

Positioning the first guide assembly at 610 may include positioning the first guide assembly on a first side of a circular saw blade of the circular saw. Examples of the first guide assembly are disclosed herein with reference to guide assemblies 30.

Positioning the second guide assembly at 620 may include positioning the second guide assembly on a second side of the circular saw blade. Examples of the second guide assembly are disclosed herein with reference to guide assemblies 30.

Operating the circular saw at 630 may include operating the circular saw for at least a threshold operating time. This may include operating while the first guide assembly is positioned on the first side of the circular saw blade and also while the second guide assembly is positioned on the second side of the circular saw blade. Stated another way, the operating at 630 may include operating the circular saw without removing the first guide assembly from the circular saw and/or without removing the second guide assembly from the circular saw.

Examples of the threshold operating time include threshold operating times of at least 1 day, at least 2 days, at least 3 days, at least 4 days, at least 5 days, at least 6 days, at least 7 days, at least 8 days, at least 9 days, at least 10 days, at least 15 days, at least 20 days, at least 25 days, at least 30 days, at least 40 days, at least 50 days, and/or at least 60 days. Additional or alternative examples of the threshold operating time include threshold operating times of at most 120 days, at most 110 days, at most 100 days, at most 90 days, at most 80 days, at most 70 days, at most 60 days, at most 50 days, at most 40 days, at most 30 days, at most 20 days, and/or at most 10 days.

As discussed, conventional circular saw guide pads, which may be formed from metallic components, may only permit operation of a corresponding circular saw for a few hours or, at most, a few tens-of-hours before it becomes necessary to replace and/or refurbish the conventional circular saw guide pads. In contrast, the circular saw blade guide pads disclosed herein permit operation of corresponding circular saws for the above-disclosed threshold operating times, significantly decreasing maintenance time and/or operational costs for circular saws that incorporate the circular saw blade guide pads that are disclosed herein.

Providing the fluid at 640 may include providing any suitable fluid, or fluid stream, to a first contact region between the first guide assembly and the first side of the circular saw blade and/or to a second contact region between the second guide assembly and the second side of the circular saw blade. This may include providing the fluid to lubricate the saw blade, to cool the saw blade, and/or to form a fluid bearing between the saw blade and the guide assemblies. The providing at 640 may be performed during, or concurrently with, the operating at 630, and examples of the fluid are disclosed herein with reference to fluid stream 42.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are at least 75% as long as the second length and also includes first lengths that are as long as the second length. As yet another example, elements that are at least substantially parallel includes elements that extend in directions that deviate by up to 22.5° and also includes elements that are parallel.

Illustrative, non-exclusive examples of circular saw blade guide pads, circular saw guide assemblies, circular saws, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A circular saw blade guide pad, comprising:

a pad body, wherein the pad body includes a pad material, and further wherein the pad body defines a guide surface configured to contact a circular saw blade, wherein the pad material includes:

(i) a first plurality of small graphite particles, wherein a first threshold fraction of the first plurality of small graphite particles defines at most a first threshold particle size;

(ii) a second plurality of large graphite particles, wherein a second threshold fraction of the second plurality of large graphite particles defines at least a second threshold particle size, wherein the second threshold particle size is greater than the first threshold particle size; and

(iii) at least one additional component that defines a remainder of the pad material, wherein the at least one additional component includes a cured resin material, wherein the cured resin material is bound to the first plurality of small graphite particles and to the second plurality of large graphite particles to define the pad body.

A2. The guide pad of paragraph A1, wherein the first plurality of small graphite particles includes a first plurality of naturally occurring small graphite particles.

A3. The guide pad of any of paragraphs A1-A2, wherein the first plurality of small graphite particles defines a first weight percentage of the pad material.

A4. The guide pad of paragraph A3, wherein the first weight percentage of the pad material includes at least one of:

(i) at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, at least 30 wt %, at least 32 wt %, at least 34 wt %, at least 36 wt %, at least 38 wt %, at least 40 wt %, at least 42 wt %, at least 44 wt %, at least 46 wt %, at least 48 wt %, or at least 50 wt % of the pad material; and

(ii) at most 60 wt %, at most 58 wt %, at most 56 wt %, at most 54 wt %, at most 52 wt %, at most 50 wt %, at most 48 wt %, at most 46 wt %, at most 44 wt %, at most 42 wt %, at most 40 wt %, at most 38 wt %, at most 36 wt %, at most 34 wt %, at most 32 wt %, at most 30 wt % at most 28 wt %, at most 26 wt %, at most 24 wt %, at most 22 wt %, or at most 20 wt % of the pad material.

A5. The guide pad of any of paragraphs A1-A4, wherein the first threshold fraction of the first plurality of small graphite particles includes at least one of:

(i) at least 70 wt %, at least 72 wt %, at least 74 wt %, at least 76 wt %, at least 78 wt %, at least 80 wt %, at least 82 wt %, at least 84 wt %, at least 86 wt %, at least 88 wt %, at least 90 wt %, at least 92 wt %, at least 94 wt %, at least 96 wt %, or at least 98 wt % of the first plurality of small graphite particles; and

(ii) at most 100 wt %, at most 98 wt %, at most 96 wt %, at most 94 wt %, at most 92 wt %, at most 90 wt %, at most 88 wt %, at most 86 wt %, at most 84 wt %, at most 82 wt %, or at most 80 wt % of the first plurality of small graphite particles.

A6. The guide pad of any of paragraphs A1-A5, wherein a ratio of the first threshold particle size to the second threshold particle size is at least one of:

(i) at least 0.1, at least 0.2, at least 0.3, at least 0.4, or at least 0.5; and

(ii) at most 0.8, at most 0.7, at most 0.6, at most 0.5, at most 0.4, at most 0.3, or at most 0.2.

A7. The guide pad of any of paragraphs A1-A6, wherein the first threshold particle size is at least one of:

at least 25 microns, at least 30 microns, at least 35 microns, at least 40 microns, at least 45 microns, at least 50 microns, at least 55 microns, at least 60 microns, at least 65 microns, at least 70 microns, at least 75 microns, at least 80 microns, at least 85 microns, at least 90 microns, at least 95 microns, or at least 100 microns; and

(ii) at most 140 microns, at most 130 microns, at most 120 microns, at most 110 microns, at most 100 microns, at most 90 microns, at most 80 microns, at most 70 microns, at most 60 microns, or at most 50 microns.

A8. The guide pad of any of paragraphs A1-A7, wherein the second plurality of large graphite particles includes a second plurality of naturally occurring large graphite particles.

A9. The guide pad of any of paragraphs A1-A8, wherein the second plurality of large graphite particles defines a second weight percentage of the pad material.

A10. The guide pad of paragraph A9, wherein the second weight percentage of the pad material includes at least one of:

(i) at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, at least 30 wt %, at least 32 wt %, at least 34 wt %, at least 36 wt %, at least 38 wt %, at least 40 wt %, at least 42 wt %, at least 44 wt %, at least 46 wt %, at least 48 wt %, or at least 50 wt % of the pad material; and

(ii) at most 60 wt %, at most 58 wt %, at most 56 wt %, at most 54 wt %, at most 52 wt %, at most 50 wt %, at most 48 wt %, at most 46 wt %, at most 44 wt %, at most 42 wt %, at most 40 wt %, at most 38 wt %, at most 36 wt %, at most 34 wt %, at most 32 wt %, at most 30 wt % at most 28 wt %, at most 26 wt %, at most 24 wt %, at most 22 wt %, or at most 20 wt % of the pad material.

A11. The guide pad of any of paragraphs A1-A10, wherein the second threshold fraction of the second plurality of large graphite particles includes at least one of:

(i) at least 50 wt %, at least 52 wt %, at least 54 wt %, at least 56 wt %, at least 58 wt %, at least 60 wt %, at least 62 wt %, at least 64 wt %, at least 66 wt %, at least 68 wt %, at least 70 wt %, at least 72 wt %, at least 74 wt %, at least 76 wt %, at least 78 wt %, at least 80 wt %, at least 82 wt %, at least 84 wt %, at least 86 wt %, at least 88 wt %, at least 90 wt %, at least 92 wt %, at least 94 wt %, at least 96 wt %, or at least 98 wt % of the second plurality of large graphite particles; and

(ii) at most 100 wt %, at most 98 wt %, at most 96 wt %, at most 94 wt %, at most 92 wt %, at most 90 wt %, at most 88 wt %, at most 86 wt %, at most 84 wt %, at most 82 wt %, at most 80 wt %, at most 78 wt %, at most 76 wt %, at most 74 wt %, at most 72 wt %, at most 70 wt %, at most 68 wt %, at most 66 wt %, at most 64 wt %, at most 62 wt %, or at most 60 wt % of the second plurality of large graphite particles.

A12. The guide pad of any of paragraphs A1-A11, wherein the second threshold particle size is at least one of:

(i) at least 100 microns, at least 110 microns, at least 120 microns, at least 130 microns, at least 140 microns, at least 150 microns, at least 160 microns, at least 170 microns, at least 180 microns, at least 190 microns, or at least 200 microns; and

(ii) at most 400 microns, at most 350 microns, at most 300 microns, at most 250 microns, at most 240 microns, at most 230 microns, at most 220 microns, at most 210 microns, at most 200 microns, at most 190 microns, at most 180 microns, at most 170 microns, at most 160 microns, or at most 150 microns.

A13. The guide pad of any of paragraphs A1-A12, wherein the second plurality of large graphite particles includes a first subset of large graphite particles that defines a first subset particle size range and a second subset of large graphite particles that defines a second subset particle size range, wherein the second subset particle size range is greater than the first subset particle size range.

A14. The guide pad of paragraph A13, wherein the first subset particle size range is at least one of:

(i) at least 100 microns, at least 110 microns, at least 120 microns, at least 130 microns, at least 140 microns, at least 150 microns, at least 160 microns, at least 170 microns, at least 180 microns, at least 190 microns, or at least 200 microns; and

(ii) at most 210 microns, at most 200 microns, at most 190 microns, at most 180 microns, at most 170 microns, at most 160 microns, or at most 150 microns.

A15. The guide pad of any of paragraphs A13-A14, wherein the second subset particle size range is at least one of:

(i) at least 150 microns, at least 160 microns, at least 170 microns, at least 180 microns, at least 190 microns, at least 200 microns, at least 210 microns, at least 220 microns, at least 230 microns, at least 240 microns, or at least 250 microns; and

(ii) at most 400 microns, at most 350 microns, at most 300 microns, at most 250 microns, at most 240 microns, at most 230 microns, at most 220 microns, at most 210 microns, or at most 200 microns.

A16. The guide pad of any of paragraphs A13-A15, wherein the first subset of large graphite particles defines at least one of:

(i) at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, or at least 30 wt % of the second plurality of large graphite particles; and

(ii) at most 50 wt %, at most 48 wt %, at most 46 wt %, at most 44 wt %, at most 42 wt %, at most 40 wt %, at most 38 wt %, at most 36 wt %, at most 34 wt %, at most 32 wt %, or at most 30 wt % of the second plurality of large graphite particles.

A17. The guide pad of any of paragraphs A13-A16, wherein second subset of large graphite particles defines at least one of:

(i) at least 40 wt %, at least 42 wt %, at least 44 wt %, at least 46 wt %, at least 48 wt %, at least 50 wt %, at least 52 wt %, at least 54 wt %, at least 56 wt %, at least 58 wt %, or at least 60 wt % of the second plurality of large graphite particles; and

(ii) at most 80 wt %, at most 78 wt %, at most 76 wt %, at most 74 wt %, at most 72 wt %, at most 70 wt %, at most 68 wt %, at most 66 wt %, at most 64 wt %, at most 62 wt %, or at most 60 wt % of the second plurality of large graphite particles.

A18. The guide pad of any of paragraphs A1-A17, wherein the resin material includes, and optionally is, at least one of:

(i) a polymeric resin material;

(ii) a cross-linked polymeric resin material;

(iii) an epoxy resin material;

(iv) a phenol formaldehyde resin material;

(v) a phenolic resin material; and

(vi) a phenolic resin material that includes methacrylate-functionalized silicates.

A19. The guide pad of any of paragraphs A1-A18, wherein the resin material defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 100 wt %, at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A20. The guide pad of any of paragraphs A1-A19, wherein the at least one additional component further includes fiberglass.

A21. The guide pad of paragraph A20, wherein the fiberglass defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A22. The guide pad of any of paragraphs A1-A21, wherein the at least one additional component further includes formaldehyde.

A23. The guide pad of paragraph A22, wherein the formaldehyde defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A24. The guide pad of any of paragraphs A1-A23, wherein the at least one additional component further includes magnesium oxide.

A25. The guide pad of paragraph A24, wherein the magnesium oxide defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A26. The guide pad of any of paragraphs A1-A25, wherein the at least one additional component further includes mica.

A27. The guide pad of paragraph A26, wherein the mica defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A28. The guide pad of any of paragraphs A1-A27, wherein the at least one additional component further includes mineral fiber.

A29. The guide pad of paragraph A28, wherein the mineral fiber defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A30. The guide pad of any of paragraphs A1-A29, wherein the at least one additional component further includes woolastonite.

A31. The guide pad of paragraph A30, wherein the woolastonite defines at least one of:

(i) at least 0.1 weight percent (wt %), at least 0.5 wt %, at least 1 wt %, at least 2 wt %, at least 4 wt %, at least 6 wt %, at least 8 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 92 wt %, at least 94 wt %, at least 96 wt %, at least 98 wt %, at least 99 wt %, at least 99.5 wt %, or at least 99.9 wt % of the remainder of the pad material; and

(ii) at most 99 wt %, at most 98 wt %, at most 96 wt %, at most 94 wt %, at most 92 wt %, at most 90 wt %, at most 85 wt %, at most 80 wt %, at most 75 wt %, at most 70 wt %, at most 65 wt %, at most 60 wt %, at most 55 wt %, at most 50 wt %, at most 45 wt %, at most 40 wt %, at most 35 wt %, at most 30 wt %, at most 25 wt %, at most 20 wt %, at most 15 wt %, at most 10 wt %, at most 8 wt %, at most 6 wt %, at most 4 wt %, at most 2 wt %, at most 1 wt %, at most 0.5 wt %, or at most 0.1 wt % of the remainder of the pad material.

A32. The guide pad of any of paragraphs A1-A31, wherein the pad body is one of an extruded pad body, a machined pad body, a subtractively machined pad body, an additively manufactured pad body, and a molded pad body.

A33. The guide pad of any of paragraphs A1-A32, wherein the pad body further includes a support fabric.

A34. The guide pad of paragraph A33, wherein the support fabric is embedded within the pad body.

A35. The guide pad of any of paragraphs A1-A34, wherein the guide pad further includes a/the support fabric, wherein the pad body is operatively attached to the support fabric.

A36. The guide pad of any of paragraphs A33-A35, wherein the support fabric includes at least one of a plant-based fabric and a synthetic fabric.

A37. The guide pad of any of paragraphs A33-A36, wherein the support fabric includes at least one of a cotton fabric, a flax-fiber fabric, and a hemp-fiber fabric.

A38. The guide pad of any of paragraphs A33-A37, wherein the support fabric includes a poly (paraphenylene terephthalamide) fabric.

A39. The guide pad of any of paragraphs A1-A38, wherein the pad body has an M-scale Rockwell hardness, as measured by ASTM D-349, of at least one of:

(i) at least 60, at least 65, at least 70, at least 75, at least 80, at least 85, at least 90, at least 95, or at least 100; and

(ii) at most 120, at most 115, at most 110, at most 105, at most 100, at most 95, at most 90, at most 85, or at most 80.

A40. The guide pad of any of paragraphs A1-A39, wherein the pad body has a flexural strength, as measured by ASTM D-349, of at least one of:

(i) at least 15,000 psi, at least 15,500 psi, at least 16,000 psi, at least 16,500 psi, at least 17,000 psi, at least 17,500 psi, at least 18,000 psi, at least 18,500 psi, or at least 18,000 psi; and

(ii) at most 22,000 psi, at most 21,500 psi, at most 21,000 psi, at most 20,500 psi, at most 20,000 psi, at most 19,500 psi, at most 19,000 psi, at most 18,500 psi, or at most 18,000 psi.

A41. The guide pad of any of paragraphs A1-A40, wherein the pad body has a tensile strength, as measured by ASTM D-349, of at least one of:

(i) at least 7,000 psi, at least 7,500 psi, at least 8,000 psi, at least 8,500 psi, at least 9,000 psi, at least 9,500 psi, or at least 10,000 psi; and

(ii) at most 12,000 psi, at most 11,500 psi, at most 11,000 psi, at most 10,500 psi, at most 10,000 psi, at most 9,500 psi, or at most 9,000 psi.

A42. The guide pad of any of paragraphs A1-A41, wherein the pad body has a compressive strength, as measured by ASTM D-349, of at least one of:

(i) at least 25,000 psi, at least 25,500 psi, at least 26,000 psi, at least 26,500 psi, at least 27,000 psi, at least 27,500 psi, at least 28,000 psi, at least 28,500 psi, or at least 29,000 psi; and

(ii) at most 32,000 psi, at most 31,500 psi, at most 31,000 psi, at most 30,500 psi, at most 30,000 psi, at most 29,500 psi, at most 29,000 psi, at most 28,500 psi, or at most 28,000 psi.

A43. The guide pad of any of paragraphs A1-A42, wherein the pad body defines a fluid-providing aperture configured to provide a fluid from a fluid supply to the circular saw blade when the circular saw blade is proximal the guide pad.

A44. The guide pad of paragraph A43, wherein pad body further defines a recessed pocket configured to receive the fluid from the fluid-providing aperture and to provide the fluid to the circular saw blade.

A45. The guide pad of any of paragraphs A43-A44, wherein the pad body further defines at least one channel configured to receive the fluid from the aperture and to provide the fluid to the circular saw blade.

B1. A circular saw guide assembly, the guide assembly comprising:

a guide arm; and

the guide pad of any of paragraphs A1-A45, wherein the guide pad is operatively attached to the guide arm.

B2. The guide assembly of paragraph B 1, wherein the guide arm is a metallic guide arm.

B3. The guide assembly of any of paragraphs B1-B2, wherein the guide pad is configured to be selectively removed from the guide arm to facilitate replacement of the guide pad.

C1. A circular saw, comprising:

at least one circular saw blade defining a first blade side and an opposed second blade side;

a first guide assembly positioned on the first blade side; and

a second guide assembly positioned on the second blade side;

wherein the first guide assembly and the second guide assembly include the guide assembly of any of paragraphs B1-B3.

C2. The circular saw of paragraph C1, wherein the circular saw further includes a fluid supply system configured to provide a fluid stream to the circular saw blade via at least one of the first guide assembly and the second guide assembly.

D1. A method of manufacturing a circular saw blade guide pad, the method comprising:

providing a first plurality of small graphite particles, wherein a first threshold fraction of the first plurality of small graphite particles defines at most a first threshold particle size;

providing a second plurality of large graphite particles, wherein a second threshold fraction of the second plurality of large graphite particles defines at least a second threshold particle size, wherein the second threshold particle size is greater than the first threshold particle size; and

providing at least one additional component, wherein the at least one additional component includes an uncured resin material; and

forming a mixture of the first plurality of small graphite particles, the second plurality of large graphite particles, and the at least one additional component, wherein the first plurality of small graphite particles forms a first weight percentage of the mixture, wherein the second plurality of large graphite particles forms a second weight percentage of the mixture, and further wherein the at least one additional component forms a remainder of the mixture; and

curing the mixture to bind the resin material to the first plurality of small graphite particles and to the second plurality of large graphite particles to define a pad body of the guide pad.

D2. The method of paragraph D1, wherein the first plurality of small graphite particles includes any suitable structure of the first plurality of small graphite particles of any of paragraphs A1-A45.

D3. The method of any of paragraphs D1-D2, wherein the second plurality of large graphite particles includes any suitable structure of the second plurality of large graphite particles of any of paragraphs A1-A45.

D4. The method of any of paragraphs D1-D3, wherein the at least one additional component includes any suitable structure of the at least one additional component of any of paragraphs A1-A45.

D5. The method of any of paragraphs D1-D4, wherein, subsequent to the forming and prior to the curing, the method further includes positioning the mixture within a mold such that, subsequent to the curing, a shape of the guide pad corresponds to a shape of the mold.

D6. The method of any of paragraphs D1-D5, wherein, subsequent to the curing, the method includes machining the pad body to form at least one surface of the guide pad.

D7. The method of any of paragraphs D1-D6, wherein the method further includes operatively attaching the guide pad to a guide arm to define a circular saw guide assembly.

E1. A method of utilizing a circular saw, the method comprising:

positioning a first guide assembly on a first side of a circular saw blade, wherein the first guide assembly includes the guide assembly of any of paragraphs B1-B3;

optionally positioning a second guide assembly on a second side of the circular saw blade, wherein the second guide assembly includes the guide assembly of any of paragraphs B1-B3; and

operating the circular saw for a threshold operating time while the first guide assembly is positioned on the first side of the circular saw blade and optionally while the second guide assembly is positioned on the second side of the circular saw blade.

E2. The method of paragraph E1, wherein the operating includes rotating the circular saw blade relative to the first guide assembly and the second guide assembly

E3. The method of any of paragraphs E1-E2, wherein the threshold operating time includes at least one of:

(i) at least 1 day, at least 2 days, at least 3 days, at least 4 days, at least 5 days, at least 6 days, at least 7 days, at least 8 days, at least 9 days, at least 10 days, at least 15 days, at least 20 days, at least 25 days, at least 30 days, at least 40 days, at least 50 days, or at least 60 days; and

(ii) at most 120 days, at most 110 days, at most 100 days, at most 90 days, at most 80 days, at most 70 days, at most 60 days, at most 50 days, at most 40 days, at most 30 days, at most 20 days, or at most 10 days.

E4. The method of any of paragraphs E1-E3, wherein, during the operating, the method further includes providing a fluid to a first contact region between the first guide assembly and the first side of the circular saw blade and also to a second contact region between the second guide assembly and the second side of the circular saw blade.

### INDUSTRIAL APPLICABILITY

The systems and methods disclosed herein are applicable to the circular saw blade, lumber, and lumber mill industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A circular saw blade guide pad, comprising:
a pad body, wherein the pad body includes a pad material, and further wherein the pad body defines a guide surface configured to contact a circular saw blade, wherein the pad material includes:
(i) a first plurality of small graphite particles, wherein a first threshold fraction of the first plurality of small graphite particles defines at most a first threshold particle size;
(ii) a second plurality of large graphite particles, wherein a second threshold fraction of the second plurality of large graphite particles defines at least a second threshold particle size, wherein the second threshold particle size is greater than the first threshold particle size; and
(iii) at least one additional component that defines a remainder of the pad material, wherein the at least one additional component includes a cured resin material, wherein the cured resin material is bound to the first plurality of small graphite particles and to the second plurality of large graphite particles to define the pad body.

2. The guide pad of claim 1, wherein the first plurality of small graphite particles defines a first weight percentage of the pad material, wherein the first weight percentage of the pad material is at least 10 wt % and at most 60 wt % of the pad material.

3. The guide pad of claim 1, wherein the first threshold fraction of the first plurality of small graphite particles is at least 70 wt % and at most 100 wt % of the first plurality of small graphite particles.

4. The guide pad of claim 1, wherein a ratio of the first threshold particle size to the second threshold particle size is at least 0.1 and at most 0.8.

5. The guide pad of claim 1, wherein the first threshold particle size is at least 25 microns and at most 140 microns.

6. The guide pad of claim 1, wherein the second plurality of large graphite particles defines a second weight percentage of the pad material, wherein the second weight percentage of the pad material is at least 10 wt % and at most 60 wt % of the pad material.

7. The guide pad of claim 1, wherein the second threshold fraction of the second plurality of large graphite particles is at least 50 wt % and at most 100 wt % of the second plurality of large graphite particles.

8. The guide pad of claim 1, wherein the second threshold particle size is at least 100 microns and at most 400 microns.

9. The guide pad of claim 1, wherein the second plurality of large graphite particles includes a first subset of large graphite particles that defines a first subset particle size range and a second subset of large graphite particles that defines a second subset particle size range, wherein the second subset particle size range is greater than the first subset particle size range, wherein the first subset particle size range is at least 100 microns and at most 200 microns, and wherein the second subset particle size range is at least 200 microns.

10. The guide pad of claim 1, wherein the resin material includes at least one of:
(i) a polymeric resin material;
(ii) a cross-linked polymeric resin material;
(iii) an epoxy resin material;
(iv) a phenol formaldehyde resin material;
(v) a phenolic resin material; and
(vi) a phenolic resin material that includes methacrylate-functionalized silicates.

11. The guide pad of claim 1, wherein the resin material defines at least 10 wt % and at most 100 wt % of the remainder of the pad material.

12. The guide pad of claim 1, wherein the at least one additional component further includes at least one of:
(i) fiberglass;
(ii) formaldehyde;
(iii) magnesium oxide;
(iv) mica;
(v) mineral fiber; and
(vi) woolastonite.

13. A circular saw guide assembly, the guide assembly comprising:
a guide arm; and
the guide pad of claim 1, wherein the guide pad is operatively attached to the guide arm.

14. A circular saw, comprising:
at least one circular saw blade defining a first blade side and an opposed second blade side;
a first guide assembly positioned on the first blade side; and
a second guide assembly positioned on the second blade side;
wherein the first guide assembly and the second guide assembly include the guide assembly of claim 13.

15. A method of utilizing a circular saw, the method comprising:
positioning a guide assembly on a side of a circular saw blade, wherein the guide assembly includes the guide assembly of claim 13; and
operating the circular saw for a threshold operating time while the guide assembly is positioned on the side of the circular saw blade.

16. The method of claim 15, wherein the threshold operating time is at least 5 days.

17. A method of manufacturing a circular saw blade guide pad, the method comprising:
providing a first plurality of small graphite particles, wherein a first threshold fraction of the first plurality of small graphite particles defines at most a first threshold particle size;
providing a second plurality of large graphite particles, wherein a second threshold fraction of the second plurality of large graphite particles defines at least a second threshold particle size, wherein the second threshold particle size is greater than the first threshold particle size; and
providing at least one additional component, wherein the at least one additional component includes an uncured resin material; and
forming a mixture of the first plurality of small graphite particles, the second plurality of large graphite particles, and the at least one additional component, wherein the first plurality of small graphite particles forms a first weight percentage of the mixture, wherein the second plurality of large graphite particles forms a second weight percentage of the mixture, and further wherein the at least one additional component forms a remainder of the mixture; and
curing the mixture to bind the resin material to the first plurality of small graphite particles and to the second plurality of large graphite particles to define a pad body of the guide pad.

18. The method of claim 17, wherein, subsequent to the forming and prior to the curing, the method further includes positioning the mixture within a mold such that, subsequent to the curing, a shape of the guide pad corresponds to a shape of the mold.

19. The method of claim 17, wherein, subsequent to the curing, the method includes machining the pad body to form at least one surface of the guide pad.

20. The method of claim 17, wherein the method further includes operatively attaching the guide pad to a guide arm to define a circular saw guide assembly.
